(19) United States
(12) Patent Application Publication
(10) Pub. No.: US 2018/0089193 A1
(43) Pub. Date: Mar. 29, 2018

(54) Category-based data analysis system for processing stored data-units and calculating their relevance to a subject domain with exemplary precision, and a computer-implemented method for identifying from a broad range of data sources, social entities that perform the function of Social Influencers

(71) Applicant: Simon Bruce Knight, Mill Valley, CA (US)

(72) Inventor: Simon Bruce Knight, Mill Valley, CA (US)

(73) Assignee: SWACK Holdings Inc., Corte Madera, CA (US)

(21) Appl. No.: 15/276,694

(22) Filed: Sep. 26, 2016

(51) Int. Cl. G06F 17/30

(52) U.S. Cl. CPC G06F 17/3053; G06F 17/30864

(57) ABSTRACT

A category-based data analysis system for processing stored data-units and calculating their relevance to a subject domain with exemplary precision over Web and electronic document searches. A central processor parses a search definition comprising queries against target data sources, and a Boolean expression before launching a plurality of search engines. The Boolean expression and subexpressions comprise individual key-phrases and categories of key-phrases. Fine control of natural language matching behavior is controlled by parameters at the category and key-phrase level. The search engine reads data-units from a plurality of data sources, evaluates relevance, and stores metadata with the data-unit comprising relevance data by key-phrase and category. These results can be further analyzed by SQL query engines, spreadsheets, and Business Intelligence tools.

A computer-implemented method for identifying from a broad range of data sources, social entities that perform the function of Social Influencers. The method aggregates relevant results to provide a more comprehensive analysis of a subject domain than can be achieved with a manual search. Search results are presented in the form of web-presences that are logically related webpages, disaggregated and categorized from websites. Web-presences can be clustered by association with a social entity and are ranked to determine their function as Social Influencers. These results can be further analyzed by SQL query engines, spreadsheets, and Business Intelligence tools.

### CROSS-REFERENCE TO RELATED APPLICATIONS

This application claims the benefit of provisional patent application Ser. No. 62233529, filed Sep. 28 2015 by the present inventor.

### FEDERALLY SPONSORED RESEARCH

Nonapplicable.

### SEQUENCE LISTING OR PROGRAM

Nonapplicable.

### BACKGROUND

This application relates to the analysis of data, particularly its relevance to a subject domain, and the analysis of social entities' presence on the World Wide Web and their potential role as Social Influencers.

### BACKGROUND—PRIOR ART

The following is a listing of some prior art that presently appears relevant:

### U.S. Pat. Nos.

| | | |
|---|---|---|
| 5,933,822 | Aug. 3, 1999 | Braden-Harder et al. |
| 7,146,361 | Dec. 5, 2006 | Andrei Z Broder et al. |
| 7,433,893 | Oct. 7, 2008 | Douglas B. Lowry |
| 8,620,905 | Dec. 31, 2013 | Joseph Ellsworth et al. |
| 9,378,204 | Jun. 28, 2016 | Kay Mueller et al. |
| 9,348,917 | May 24, 2016 | Tetsuro Motoyama et al. |
| 8,589,413 | Nov. 19, 2013 | Rengaswamy Mohan et al. |
| 9,015,128 | Apr. 21, 2015 | Chao Qin et al. |
| 9,154,838 | Oct. 6, 2015 | Paul D. Arling. |
| 9,418,391 | Aug. 16, 2016 | Shyam Kumar Doddavula et al. |

### Non-patent Literature Documents

http://www.merriam-webster.com
http://www.worldwidewebsize.com
http://www.internetlivestats.com
http://www.smartinsights.com/
https://www.searchenginejournal.com/identify-best-socialmedia-influencers/140074/
https://klout.com/corp/score
http://www.linqia.com/platform/
http://getlittlebird.com/
https://www.linkdex.com
B. Katz, “Annotating the World Wide Web using Natural Language” Conference Proceedings of RIAO 97, Computer-Assisted Information Searching in Internet, McGill University, Quebec, Canada, Jun. 25-27 1997, vol. 1, pp. 136-155
A T. Arampatzis et al “IRENA: Information Retrieval Engine based on Natural language Analysis”, Conference Proceedings of RIAO 97, Computer-Assisted Information Searching in Internet, McGill University, Quebec, Canada, Jun. 25-27, 1997, vol. 1, pp. 159-175

For the purposes of the embodiments of this invention, the following definitions are used herein:
a) A web page is defined as a data-unit on the World Wide Web (The Web), comprising an HTML file, any related files for scripts and graphics, and often hyperlinked to other documents on the Web. The content of a web page is normally accessed and displayed by using a browser computer program.
b) A Website, defined by http://www.merriam-webster.com is “a place on the World Wide Web that contains information about a person, organization, etc., and that usually consists of many web pages joined by hyperlinks”. A website is considered to be those pages sharing a common domain or sub-domain in their URL. No assumptions are made, or needed, regarding the physical hosting or organization of the pages on a server, other than the relationship of HTML links.
c) Social Media, defined by http://www.merriam-webster.com are “forms of electronic communication (as Web sites for social networking and microblogging) through which users create online communities to share information, ideas, personal messages, and other content (as videos)”. Social Media sites aggregate the accounts of millions of users and often utilize techniques that measure a user's influence, ‘Likes’ and ‘Followers’, and hashtags that flag content.
d) A blog is defined by http://www.merriam-webster.com as “a Web site that contains online personal reflections, comments, and often hyperlinks provided by the writer; also, the contents of such a site.” Importantly, blog posts frequently generate conversation in the form of comments, and bloggers can be important Social Influencers.
e) A forum is defined broadly by http://www.merriam-webster.com as “a place or opportunity for discussing a subject”. In the context of the Web, an online forum is a site that provides a place for (usually registered) users to post comments on topics related to a subject domain. Online forums may be sponsored by an organization or individuals, and frequently use moderators to police conversations, all of which may be Social Influencers.
f) A Web store is any site that conducts transactions with consumers or businesses. Stores may be dedicated to a company's products or sell almost anything, like Amazon.com. These sites often contain reviews of products written by buyers (purportedly), and may have forums associated with them for product discussions and support.
g) Reviews are common on Web stores as described above, and on dedicated review sites focusing on subject domains such as travel. Frequent and well-regarded reviewers can be Social Influencers.
h) A data-unit is defined as any electronic representation of text in a single file. It may be an HTML web page or a format created and readable by a software application or code such as an Adobe PDF or Microsoft Office document.
i) A document library is defined as computer data store of documents, accessible with an index.
j) A key-phrase is defined as one or more keywords used together in a single expression, for example in a search query.

### Natural Language Search Technology

While most Internet users will be familiar with search engines, performing a comprehensive and precise search of the Internet is challenging. Comprehensiveness is defined herein as finding all relevant data-units, and precision as excluding non-relevant data-units.

The Internet and World Wide Web (the Web) are huge. According to www.worldwidewebsize.com, as of August 2016, Google's index contains between 45 and 50 billion pages. And this data is volatile: http://www.internetlivestats.com/ counts over 4 billion new blog posts per day. Google or Bing can return millions of results in seconds; however, in practice they have significant limitations:
a) Many of their results are marginally relevant and can be popular but useless sites designed to attract clicks and generate advertising revenue (click bait).
b) Refining these searches can be fruitless: while these search engines do support the use of multiple key-phrases and Boolean logic, if too many key-phrases and/or subexpressions are used, queries often return zero results.
c) Commercial considerations such as paid advertising influence the presentation of results, particularly on the first few pages.
d) The detailed workings of their search algorithms such as phrase matching are not fully disclosed and cannot be fine-tuned by the user.
e) While the search engines index a significant portion of the Web, some relevant sites are not included in the search results or are ranked too low to be visible.
f) A comprehensive web search requires multiple queries, collating many thousands of search results, and manual inspection of potentially millions of pages, a process that is extremely time consuming and impractical in most cases.

Search technology using Natural Language Processing has been in common usage for a number of years. B. Katz, “Annotating the World Wide Web using Natural Language” [Conference Proceedings of RIAO 97, Computer-Assisted Information Searching in Internet, McGill University, Quebec, Canada, Jun. 25-27 1997, vol. 1, pp. 136-155, and A T. Arampatzis et al] and [“IRENA: Information Retrieval Engine based on Natural language Analysis”, Conference Proceedings of RIAO 97, Computer-Assisted Information Searching in Internet, McGill University, Quebec, Canada, Jun. 25-27, 1997, vol. 1, pp. 159-175] both document fundamental techniques employed.

These techniques have since been refined and expanded. U.S. Pat. No. 5,933,822 [Aug. 3, 1999 Braden-Harder et al.] describes an apparatus and methods for an information retrieval system that employs basic natural language processing to improve overall precision. U.S. Pat. No. 7,146,361 [Dec. 5, 2006 Andrei Z Broder et al.] describes the use of a search operator functioning as a weighted AND to improve precision. U.S. Pat. No. 7,433,893 [Oct. 7, 2008 Douglas B. Lowry] describes a method for using proximity data for efficient text searches that improves the matching of key-phrases with multiple keywords by controlling the number of non-keywords allowed between keywords.

The true meaning of keywords is often ambiguous, and the use of an ontology, defined herein as a list of words related to a subject domain, can improve the precision of a search by evaluating the relevance of words nearby a keyword to determine context (U.S. Pat. No. 8,620,905 Dec. 31, 2013 Joseph Ellsworth et al.), and by matching valid synonyms (U.S. Pat. No. 9,378,204 Jun. 28, 2016 Kay Mueller et al.) U.S. Pat. No. 9,348,917 [May 24,2016 Tetsuro Motoyama et al.] also describes the use of semantic meaning in a search language. Nevertheless, the fine control over search parameters remains a challenge.

In terms of comprehensiveness, U.S. Pat. No. 8,589,413 [Nov. 19, 2013 Rengaswamy Mohan et al.] presents a method for dynamically analyzing results from search engines. However, the lack of precision and comprehensiveness of these results is not fully addressed.

Many of these advances are used in popular search technologies. SQL is designed to query relational databases, and while it contains features such as wildcard matching where the ‘?’ and ‘*’ will match any single or multiple alphanumeric characters respectively, control of matching words and phrases (key-phrases) within a query is rudimentary.

Search engine queries as employed by Google and Bing use Boolean expressions comprising key-phrases and operators. Phrases are matched exactly, although wildcards at the word level are supported, and Bing provides a rudimentary word proximity feature where components of a phrase match if they are within a specified number of words of each other, for example: foo near: 10 bar specifies a match if foo is found within 10 words of bar. Both search engine queries provide results based on aggregate ranking, and don't provide the ability to filter by the relevance of each term in the query.

Specialized text search languages such as Contextual Query Language (CQL) are also based on Boolean expressions and include features such as query specific document fields and contextual queries that rely on ontologies to provide information on related concepts and entities. CQL has a rudimentary proximity feature.

These existing query languages have a some or all of the following deficiencies that reduce the precision and completeness of their results:
a) They lack the ability to fine tune phrase matching.
b) Aggregate ranking doesn't support refinement and analysis of query results.
c) They can't test for a minimum number of occurrences from a selection. A query with a number of Boolean OR'ed terms comes close, but the use of too many terms cause the query to fail.
d) There is no ability to weight the relative importance of terms.
e) There is no control of matching lemmas, stems, and soundex. A lemma refers to the particular form of a word that is chosen by convention to represent all forms and tenses. A stem is the root of a words forms and tenses. Soundex is a representation of the sound of a word, and will match any word with the same sound.
f) There is no precise control over matching with synonyms or similar sounding words.

### Identifying Social Influencers

Social Media usage is growing: http://www.smartinsights.com/ claims that Facebook has over 1.5 billion active users globally, and according to http://www.internetlivestats.com there are almost 3.5 billion Internet users and over 1 billion websites. The Internet and Social Media have become critically important marketing tools and sales channels for many organizations, so called Digital Marketing. One Digital Marketing technique that has proven effective is to identify Social Influencers. If all Internet users—consumers and publishers of content—are considered to be social entities that may be either consumers or purveyors of products and services, Social Influencers are defined herein as those social entities that have, by way of their expertise, credibility, and visibility on the Internet, influence over the preferences and purchasing behavior of other social entities. Digital Marketers seek out Social Influencers to persuade them to be advocates for their offerings, while consumers look to Social Influencers for advice when selecting products. In effect, Social Influencers act as digital word of mouth.

The building blocks of the Web or a document library are not always conducive to identifying pockets of relevant information or social entities likely to be influential in a particular subject domain. None of these objects, a web page, website, document, or library is necessarily organized logically around a specific subject domain or social entity. A web page may contain information related to unconnected subjects, and a single domain or website may be an aggregation of thousands or millions of blogs. Where social entities have a presence on the Web, this may be in the form of multiple websites, pages on those websites, blogs, forum posts, comments, reviews, and Social Media pages, etc.

Existing tools and techniques for identifying Social Influencers tend to focus predominantly on Social Media sites and blogs. An article titled ‘How to identify your best Social Media Influencers’ published by the website Search Engine Journal on Sep. 11 2015, https://www.searchenginejournal.com/identify-best-socialmedia-influencers/140074/, focuses on manual searches of individual Social Media sites such as Facebook, Twitter, and Llnkedin. Tools like Klout, https://klout.com/corp/score, link a user's Social Networks including Social Media sites and blogs to create a rating, Klout Score, of their following as Social Influencers. This is a useful tool for assessing a social entity's level of influence; however, it does not solve the problem of identifying relevant Social Influencers or assessing their level of influence if they do not make use of Klout Scores.

Existing platforms such as http://www.lingia.com/platform/ have built up libraries of Social Influencers gleaned from Social Media and blogs. Little Bird, http://getlittlebird.com/, focuses only on Twitter. Linkdex https://www.linkdex.com utilizes a proprietary search engine that identifies content authors when looking for Social Influencers. However, none of these approaches are a substitute for analyzing a social entity's entire web-presence beyond Social Media and blog participation.

Techniques used to identify Social Influencers also focus on the creation, sharing, and consumption of content. U.S. Pat. No. 9,015,128 [Apr. 21, 2015 Chao Qin et al.] describes a method for measuring social influence and the receptivity of users by creating a social sharing graph. Similarly U.S. Pat. No. 9,154,838 [Oct. 6, 2015 Paul D. Arling.] describes a method for identifying social media influencers by scoring based on content generation and consumption. U.S. Pat. No. 9,418,391 [Aug. 16, 2016 Shyam Kumar Doddavula et al.] goes further by clustering content and evaluating links and frequency of viewing.

Many of these approaches to identifying Social Influencers rely on analyzing a limited number of sources, focusing mainly on established Social Media and search engine results, and therefore are likely to be less comprehensive and precise than an exemplary solution.

### SUMMARY

### Category-Based Data Analysis System for Calculating Relevance to a Subject Domain

According to the embodiment of the invention, problems and disadvantages associated with previous techniques for calculating the relevance of data-units to a subject domain have been substantially reduced. One embodiment of the invention is a data analysis system for processing stored data and calculating the relevance of data-units to a subject domain with exemplary precision comprises a central processor, a plurality of search engines, and a computer storage medium. The central processor parses a search definition, queries data sources comprising a plurality of databases, HTML servers, and Social Media websites, and retrieves data identifiers for data-units potentially relevant to the subject domain as specified by the search definition. The central processor then creates a series of tasks for a plurality of search engines that execute on multiple CPUs and servers. The search engine interprets these tasks, retrieves the specified data-units from a series of data sources and uses the search definition to evaluate the relevance of the data-units.

The search definition comprises a plurality of subexpressions each linked by a Boolean operator where the subexpression may comprise a key-phrase, category, or another said subexpression. The evaluation of these subexpressions as TRUE calculates the data-unit's relevance and the data-unit's relevance is stored as metadata on the computer storage medium. When an embodiment of the invention crawls websites, the search engine evaluates the relevance of the website by aggregating the metadata of each data-unit belonging to the website. The search definition may be created using methods comprising a computer language and a graphical user interface.

A natural language processor evaluates a series of match factors comprising case sensitivity, wildcards, synonyms, lemmas, soundex, stemming, the word range used in proximity matching, the minimum number of occurrences, relative weighting, and whether a key-phrase is mandatory for the category to evaluate TRUE in the Boolean expression. Optional key-phrase parameters specify which of the match factors are active for each key-phrase. A series of optional category parameters specify the default key-phrase parameters for each key-phrase contained in a category, and the minimum number of key-phrases that must be present. A series of search dimensions can also be defined independent of categories and combined with categories and key-phrases to provide secondary analytical capabilities using industry standard business intelligence tools.

This embodiment is able to analyze data-units found in the initial data source queries which represent the best efforts of existing search technologies and then expand the search to include data-units that were omitted or not considered relevant by those data sources, thus performing a more comprehensive search. In addition, the benefits of categories in the Boolean expression and key-phrase parameters are:
a) The ability to define a specific set of allowable synonyms or related key-phrases that would not otherwise be recognized by a query engine.
b) The ability to define default matching behavior for a set of key-phrases.
c) To measure relevance by category.
d) To include a data-unit in a result set if only a proportion of the specified words are present.
e) To control precisely which natural language techniques are used for each keyword.

### Identifying Social Influencers from a Broad Range of Data Sources

According to the present embodiment of the invention, problems and disadvantages associated with previous techniques for identifying Social influencers in a subject domain have been substantially reduced. One embodiment is a computer-implemented method for identifying from a broad range of data sources, social entities that perform the function of Social Influencers relevant to a subject domain. Comprises a central processor and a computer storage medium. The central processor executes the steps of retrieving information from the computer storage medium comprising data-units corresponding to webpages and websites, and metadata comprising relevance of these data-units and links to other said webpages. The central processor then identifies groups of data-units within websites related to social entities and creates web-presence metadata describing these groups. Where websites are shared by a plurality of social entities, they are disaggregated into a series of web-presences related to each social entity. Web pages are also categorized based on their function comprising forum, group, social network account, web store, and general website, and the website subdivided according to those functions, and web-presence metadata created for each subdivision.

The central processor creates a series of clusters of web-presences associated with social entities, creates a ranking factor for the social entities by analyzing a series of criteria and the relevance of the web-presence, and flags social entities likely to be said Social Influencers based on the ranking factor. The ranking factor is based on the number and weighting of HTML links, the quality and quantity of interaction with other social entities, and a series of measures defined by Social Media and websites comprising likes, followers, and user ratings.

This embodiment ensures that the resulting list of social entities is drawn from a broad selection of relevant data sources, providing a comprehensive picture of social entities' potential value as Social Influencers with exceptional visibility and credibility and who are likely to influence the preferences and behavior of other said social entities.

Further embodiments of the inventions described herein can provide a more functional and efficient view of the web, including but not limited to promotions, branding, research, identifying distribution channels; traffic analysis, web site optimization, general communication among people sharing common interests, or any activity that consumes information from the Web.

### BRIEF DESCRIPTION OF DRAWINGS

The aspects of the disclosure will be better understood with the accompanying drawings:

FIG. 1 is a block diagram of the data analysis system for processing stored data and calculating the relevance of data-units to a subject domain with exemplary precision.

FIG. 2 illustrates the processing structure of the system in FIG. 1.

FIG. 3 illustrates the steps executed by the central processor and search engine.

FIG. 4 illustrates the search definition used by the system in FIG. 1.

FIG. 5 is a block diagram of the computer-implemented method for identifying from a broad range of data sources, social entities that perform the function of Social Influencers relevant to a subject domain.

FIG. 6 illustrates the steps executed by the computer-implemented method in FIG. 5.

FIG. 7 illustrates the disaggregation of websites and creation of web-presences.

FIG. 8 illustrates the categorization of websites and creation of web-presences.

FIG. 9 illustrates the clustering of web-presences.

### DETAILED DESCRIPTION

The embodiments described herein are related to the evaluation of relevance of data-units and the identification of Social Influencers in a subject domain. While the particular embodiments described herein may illustrate the inventions in a particular domain, the broad principles behind these embodiments could be applied in other fields of endeavor. To facilitate a clear understanding of the present disclosure, illustrative examples are provided herein which describe certain aspects of the disclosure. However, it is to be appreciated that these illustrations are not meant to limit the scope of the disclosure, and are provided herein to illustrate certain concepts associated with the disclosure. It is also to be understood that the present disclosure may be implemented in various forms of hardware, software, firmware, special purpose processors, cloud computing services, or a combination thereof. Preferably, the present embodiment of the invention is implemented in software as a program tangibly embodied on a processor and computer storage medium. The program may be uploaded to, and executed by, a machine comprising any suitable architecture.

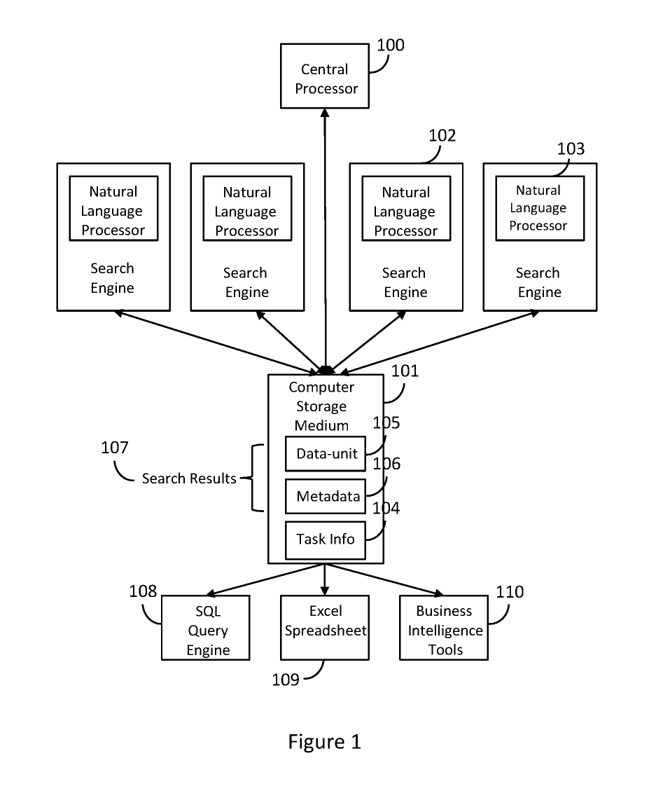

### Data Analysis System Illustrated in FIGS. 1-4

The data analysis system illustrated in FIGS. 1-4 processes stored data that may be read from the Internet, a database, or document library, or any source of information. Its purpose is to analyze the data's relevance to a subject domain, as expressed in a text query. Relevance is assessed relative to discrete data-units, which may be web pages, text documents, the results of a database query, or any unit of computer readable text. A measure of overall relevance and the relevance related to each of the query's terms are stored as metadata associated with each data-unit. Where this embodiment improves upon prior art is the control over text matching provided by the search engine and its associated category-based query language:
Categories comprising one or more key-phrases.
Search parameters that may be specified at the category and key-phrase level.
The creation and storing of search metadata related to categories, key-phrases, and dimensions that can be further analyzed to filter and rank large result sets.

FIG. 1 is a block diagram of the data analysis system. The system comprises a central processor 100 that can store and retrieve information in a computer storage medium 101. The central processor launches a plurality of search engines 102 that comprise natural language processors 103. The central processor communicates with the search engines using task instructions 104 that are stored in and retrieved from the computer storage medium. Data-units 105 and metadata 106 that represent search results 107 are stored in the computer storage medium. These search results are accessible to other tools comprising SQL query engines 108, spreadsheets 109, and Business Intelligence tools 110.

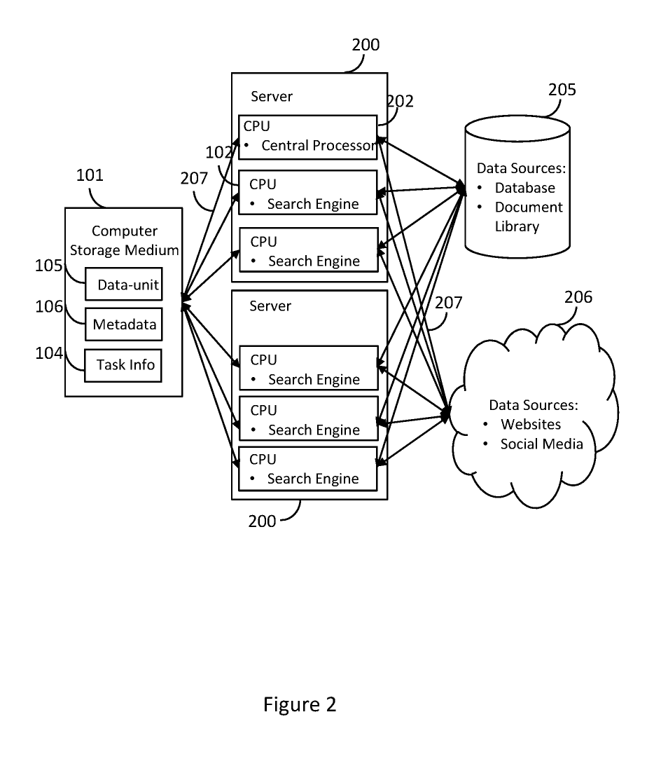

FIG. 2 illustrates the ability of the central processor to access data sources and distribute processing. The central processor runs on a server 200 that has allocated a computer CPU 202 to the process. Search Engines may be launched on other CPUs 203 running on the same or another server 200. Search engines and the central processor are capable of accessing data sources 205, the Internet 206, and the computer storage medium 101 via network links 207.

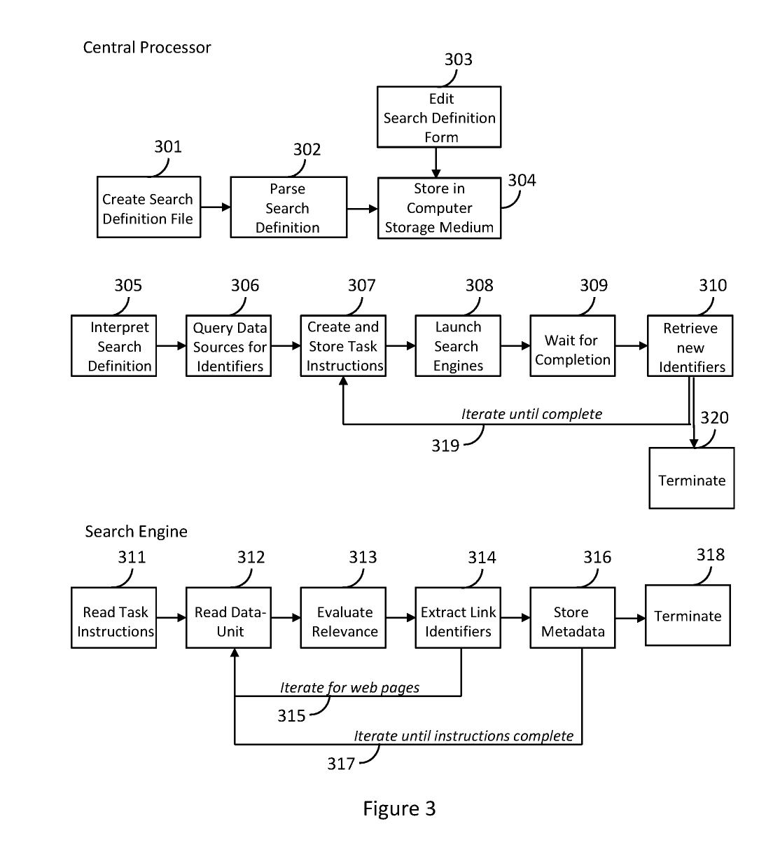

FIG. 3 illustrates the steps performed by the central processor, the search engine, and the user to conduct a search. The user creates a search definition file 301 using any text editor. The search definition is then parsed by the central processor 302 and stored in the computer storage medium 304. Alternatively, the search definition may be edited or created using a graphical user interface 303. The central processor interprets the search definition 305 and then queries the data sources specified in the search definition 306 to retrieve identifiers, comprising URLs for web pages, user names, document titles and references. In an embodiment of the invention that searches the Web, this step involves querying search engines and Social Media interfaces to extract an initial list of candidate URLs to be analyzed. The central processor allocates these identifiers to be analyzed across a number of search engines, creates task instructions comprising the list of identifiers and search instructions 307, and stores them in the computer storage medium before launching the search engines 308. The central processor then waits for the search engines to complete their tasks 309.

After being launched by the central processor, the search engine reads its task instructions from the computer storage medium 311 and executes those instructions reading each data-unit 312 referenced in the list of identifiers. The search engine uses the natural language processor to evaluate the relevance of the data-unit per the search definition 313 and extracts any identifiers 314 found. If the data-unit is a web page, the search engine will crawl all the available webpages under the website domain 315. After a data-unit is analyzed, the search engine will create and store result metadata for that data-unit in the computer storage medium 316, and if the data-units analyzed form part of a website, metadata for that website is similarly created and stored. The search engine will iterate through the list of identifiers provided by the central processor 317 and then terminate 318.

When search engines terminate, the central processor will load the new identifiers found by the search engines 310, and repeat steps 307 through 309 to analyze those data-units. These iterations 319 will be repeated as specified in the search definition before the central processor terminates 320.

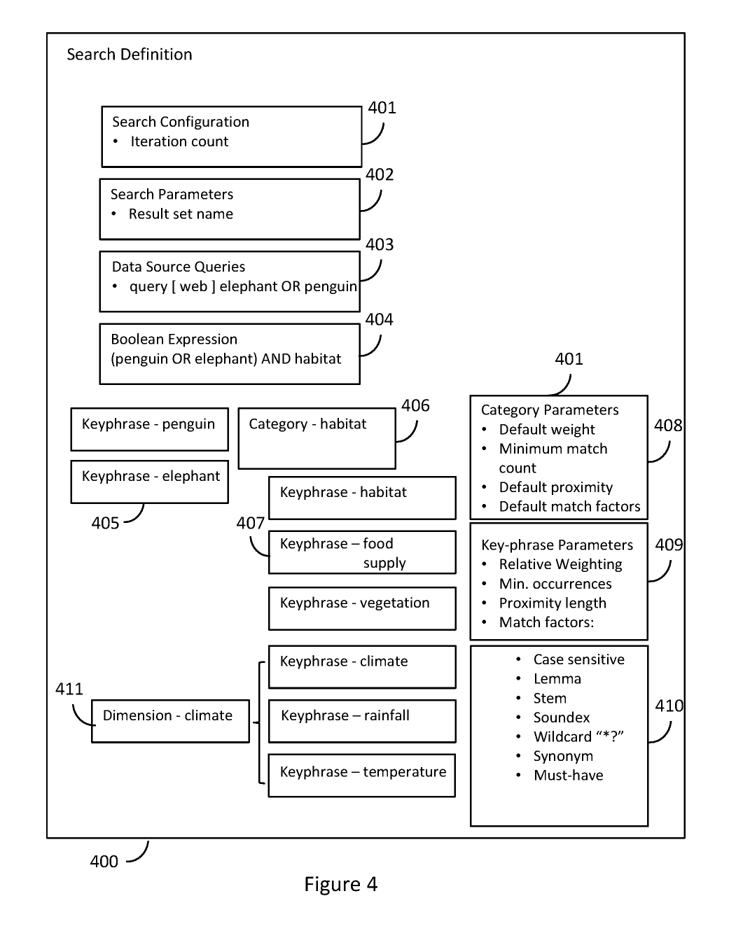

FIG. 4 illustrates the search definition 400 that controls the search engines and delivers exemplary search precision. A search configuration 401 comprises the number of search iterations 319 to be performed. Search parameters 402 comprise the name of the result set (used when retrieving results from the computer storage medium). Data source queries 403 comprise names of data sources and query terms used to retrieve the initial list of identifiers used in the search.

The core of the category-based query language of the embodiment described herein comprises a conventional Boolean expression 404 familiar to users of traditional search engines. In its simplest form, the expression comprises key-phrase terms 405 separated by Boolean operators AND, OR, NOT, and parenthesis to control the separation and precedence of terms. The query engine evaluates each term to determine whether the expression evaluates TRUE, for example: “elephant OR (monkey and penguin)”. If the word elephant is found in the data-unit or both words monkey and penguin are found, the expression will evaluate as TRUE, and the data-unit will be included in the set of relevant results.

In place of key-phrases, a category 406 may be substituted. A category comprises a list of at least one key-phrase 407 and a set of category parameters 408. The query engine will evaluate the data-unit for the presence of all the category's key-phrases and calculate a total relevance for the category, relevance for each key-phrase, and whether the category evaluates TRUE in the Boolean expression. The parameters for the category comprise:
a) An integer value for the minimum number of category key-phrases that must be found in the data-unit. For example, a category that contains three key-phrases, elephant, monkey and penguin, if the parameter is 2, at least 2 of those words must be present for the category to evaluate TRUE.
b) An integer value for the default key-phrase weighting (defined below).
c) An integer value for the default key-phrase proximity factor (defined below).
d) Default key-phrase lexical matching options (defined below).

Within each category, a series of key-phrases are defined. Each key-phrase comprises the word(s) to be matched followed by a series of matching parameters 409. If no parameters are defined, the defaults for the category are applied. The parameters for the key-phrase comprise:
a) An integer value for the minimum number of occurrences of the key-phrase that must be found in the data-unit. For example, a category that the key-phrase elephant, if the parameter is 2, at least 2 occurrences of the words must be present for the key-phrase to evaluate TRUE.
b) An integer value for the key-phrase weighting. This weighting is multiplied by the number of occurrences of the word in the data-unit to calculate its relevance.
c) An integer value for the key-phrase proximity factor. This specifies the maximum distance measure in words between the elements of the key-phrase. For example, is the key-phrase “elephant trunk” is used with a proximity factor of 2, the text “the elephant raised its trunk” would match because there are no more than 2 words between elephant and trunk. d) A series of lexical matching factors 410 comprising the use of case sensitivity, wildcards, synonyms, lemmas, soundex and stemming.

Analysis of the data-unit's relevance is further facilitated by the addition of a search dimension 411 that can be specified independently of categories.

In conclusion the embodiment described is able to analyze data-units found in the initial data source queries which represent the best efforts of existing search technologies and then expand the search to include data-units that were omitted or not considered relevant by those data sources, thus performing a more comprehensive search. In addition, the benefits of categories in the Boolean expression and key-phrase parameters are:
f) The ability to define a specific set of allowable synonyms or related key-phrases that would not otherwise be recognized by a query engine.
g) The ability to define default matching behavior for a set of key-phrases.
h) To measure relevance by category.
i) To include a data-unit in a result set if only a proportion of the specified words are present.
j) To control precisely which natural language techniques are used for each keyword.

Further embodiments of the invention described herein can provide a more comprehensive and precise search for data from any accessible data source, including but not limited to aiding academic and commercial research, or any activity that consumes information from such data sources.

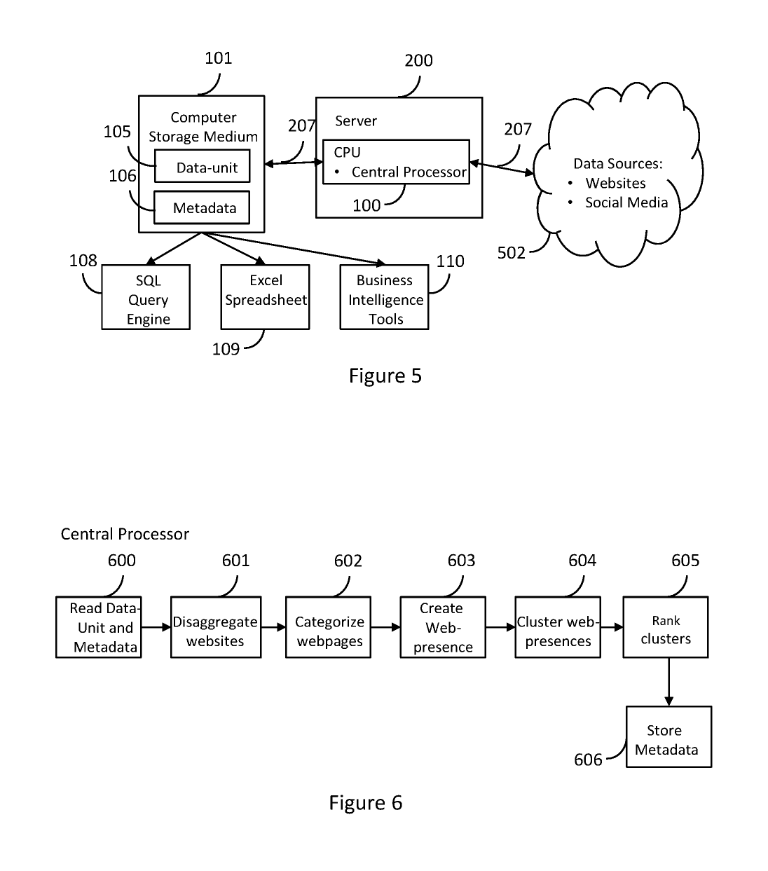

### Computer Implemented Method Illustrated in FIGS. 5-9

Existing search engines typically return links to and rank individual web pages. However, the content and relevance of a single web page only yields a simplistic analysis of the subject domain. Similarly, as previously defined herein, a website may be an arbitrary collection of web pages not associated with a single social entity or subject domain. The construct of the Web-presence as defined herein is a grouping of webpages related to a particular owner and subject domain providing a way to consume and analyze this data in a more logical way than fragmented web pages or the sometimes arbitrary grouping of pages into Websites. Categorization of web-presences also provides more information regarding their function. Clustering multiple web-presences belonging to social entity provides a view from a plurality of sources on the Web and therefore a more complete picture of a social entity's Web-based activity. This approach also provides valuable means to rank a social entity's expertise, credibility, visibility, and relevance to the subject domain.

FIG. 5 is a block diagram of the computer implemented method's computer system. The system comprises a central processor 100 that can store and retrieve information in a computer storage medium 101. The central processor is capable of accessing data sources 502 comprising websites and Social Media and the computer storage medium via network links 207. Outputs of the central processor stored in the computer storage medium are accessible to other tools comprising SQL query engines 108, spreadsheets 109, and Business Intelligence tools 110.

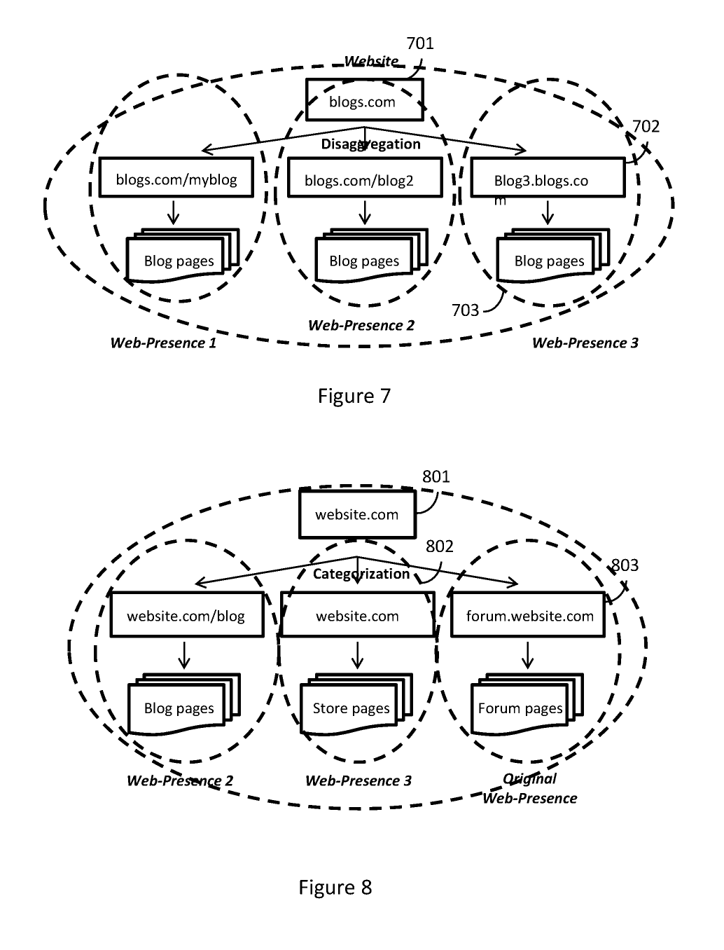

The central processor executes the steps illustrated in FIG. 6. In the first step 600, the central processor reads data-units 105 comprising web and Social Media pages and associated metadata 106 comprising relevance information and references to other data-units. The central processor then gathers information page by page related to a website before disaggregating the pages into logically related groups 601. This process is illustrated in greater detail in FIG. 7. For example, a hypothetical blogging site “blogs.com ” 701 comprises blog pages for a plurality of social entities. In step 601 the central processor disaggregates the site into groups of pages associated with each social entity 702 that will become individual web-presences 703.

In step 602, websites or groups of webpages disaggregated in step 601 are categorized and split again into groups related to a particular function. This process is illustrated in greater detail in FIG. 8. The pages of example website 801 are categorized 802 based on functions comprising blog, forum, group, social network account, web store, and general website. If the website comprises multiple categories, pages associated with each category will be grouped together 803.

When a website has been disaggregated and categorized, the central processor creates a web-presence 603 corresponding to each group of webpages and assigns an owner identifier to each web-presence 604, clusters web-presences 604 that share a common owner, and ranks those clusters 605.

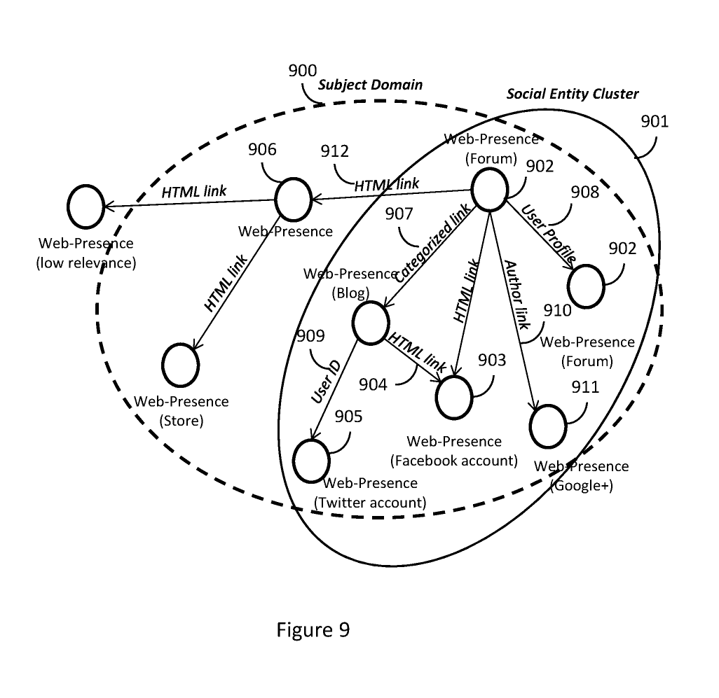

This process is illustrated in greater detail in FIG. 9. The central processor evaluates factors comprising links defined during categorization 907, HTML links to Social Media accounts 909, user profile information 908, Social Media user ids 909, authorship 910, and content relationships within the subject domain 900 to calculate the probability of ownership. In step 605, the central processor ranks the web-presences and clusters according to criteria comprising the frequency and proximity of linkages from other Web-presences (rather than single pages), weighted by the referring Web-presences' ranking and relevance. The central processor then stores metadata 606 comprising web-presences, clusters, Social Influencers, and key-phrase/key-phrase frequencies. Social Influencers are identified based on the aggregate ranking of their cluster of web-presences.

In conclusion the embodiment described is able to build a coherent and comprehensive representation of social entity's Web-presence in a subject domain, comprising websites, Social Media accounts, blogs, forum participation, comments, and reviews. Social entities can then be ranked and their potential value determined as Social Influencers who are likely to influence the preferences and behavior of other social entities.

Further embodiments of the invention described herein can provide a more functional and efficient view of the web, including but not limited to aiding marketing promotions, product and company branding, academic and commercial research, identifying distribution channels; traffic analysis, web site optimization, general communication among people sharing common interests, or any activity that consumes information from the Web.

What is claimed is:

1. A data analysis system for processing stored data and calculating the relevance of data-units to a subject domain with exemplary precision, comprising:
a. computer storage medium for storing a collection of said data-units and metadata related to said data-units; and
b. a central processor capable of parsing a search definition; and
c. said central processor is capable of querying data sources comprising a plurality of databases, HTML servers, and Social Media websites and retrieving data identifiers for said data-units potentially relevant to said subject domain as specified by said search definition; and
d. said central processor is capable of creating a series of tasks comprising said search definition and a series of said data identifiers for a search engine and storing said tasks in said computer storage medium; and
e. said central processor is capable of executing a plurality of instances of said search engine on multiple CPUs and servers, where
f. said search engine is capable of retrieving said tasks from said computer storage medium and interpreting said tasks; and
g. said search engine is capable of retrieving said data-units from a series of said data sources referred to by said data identifiers, and storing said data-units in said computer storage medium; and
h. said search engine is responsive to said search definition evaluating the relevance of each of said data-units to the said subject domain; where
i. said search definition comprises a plurality of subexpressions each linked by a Boolean operator; where:
j. said subexpression may comprise a key-phrase, category, or another said subexpression; where;
k. said key-phrase comprises at least one word; and
l. said category comprises a category name and at least one key-phrase; and
m. the evaluation of said subexpressions as TRUE calculates said data-unit's relevance to said subject domain; and
n. said data-unit's relevance is added to said metadata associated with said data-unit; and
o. said metadata is stored in said computer storage medium.

2. The system of claim 1 wherein said search definition may be created using methods comprising a computer language and edited or created using a graphical user interface.

3. The system of claim 1 wherein the matching of said key-phrases comprises the use of a natural language processor capable of evaluating a series of match factors comprising case sensitivity, wildcards, synonyms, lemmas, soundex, stemming, the word range used in proximity matching, and whether a key-phrase must be present in said category containing said key-phrase to evaluate TRUE in said subexpression.

4. The natural language processor of claim 3 wherein a series of optional key-phrase parameters specify which of the said match factors are active for each said key-phrase.

5. The natural language processor of claim 3 wherein said key-phrase parameters specify the minimum number of occurrences of a said key-phrase required for a match.

6. The natural language processor of claim 3 wherein said key-phrase parameters specify the relative weighting of said match.

7. The natural language processor of claim 3 wherein a series of optional category parameters specify the default said key-phrase parameters for each said key-phrase contained in said category.

8. The natural language processor of claim 3 wherein an optional category parameter specifies the minimum number of said key-phrases that must be present in the said data-unit for said category to evaluate TRUE in said subexpression.

9. The system of claim 1 wherein a series of search dimensions can be defined independent of said categories and combined with said categories and key-phrases to provide further analytical capability of said data-unit's relevance to said subject domain.

10. The system of claim 1 wherein an embodiment of the invention crawls a website, said search engine evaluates the relevance of said website by aggregating the metadata of each data-unit associated with said website.

11. The computer storage medium of claim 1 wherein metadata can be read and further analyzed using a series of tools comprising SQL queries, spreadsheets, and industry standard business intelligence tools.

12. A computer-implemented method for identifying from a broad range of data sources, social entities that perform the function of Social Influencers relevant to a subject domain, comprising executing on a processor the steps of:
a. retrieving information from a computer storage medium comprising data-units corresponding to webpages and websites, and metadata comprising relevance of said data-unit to said subject domain and links to other said data-units;
b. identifying groups of data-units within said websites related to said social entities and creating web-presence metadata describing said groups;
c. storing said web-presence metadata in said computer storage medium;
d. creating a series of clusters of said web-presences associated with said social entities by analyzing factors stored in said metadata;
e. Creating a ranking factor for said social entities by analyzing a series of ranking criteria and the relevance of said data-units to said subject domain;
f. Flagging said social entities likely to be said Social Influencers based on said ranking factor and storing results on said computer storage medium.

13. The computer-implemented method of claim 12 wherein said websites that are shared by a plurality of said social entities are disaggregated into a series of said web-presences related to individual said social entity.

14. The computer-implemented method of claim 12 wherein said web pages are categorized based on their website function, subdivided according to said function, and said web-presence metadata created for each said subdivision.

15. The computer-implemented method of claim 12 wherein said website functions comprise forum, group, social network account, web store, and general website.

16. The computer-implemented method of claim 12 wherein said ranking criteria for said social entities comprise the number and weighting of said HTML links, the quality and quantity of interaction with other said social entities, and a series of measures defined by Social Media and said websites comprising likes, followers, and user ratings.
Whereby the said data analysis system of claim 1 is capable of evaluating the relevance of said data-units with exemplary precision; and the computer-implemented method of claim 12 ensures that the resulting list of said social entities is drawn from a broad selection of relevant said data sources, providing a comprehensive picture of said social entities' potential value as said Social Influencers with exceptional visibility and credibility and who are likely to influence the preferences and behavior of other said social entities.
